(19) United States
(12) Patent Application Publication
(10) Pub. No.: US 2015/0310794 A1
(43) Pub. Date: Oct. 29, 2015

(54) GRAPHICAL ELEMENTS FOR WHITE-POINT CALIBRATION AND ADJUSTMENT TECHNIQUES FOR DISPLAYS

(71) Applicant: QUALCOMM Incorporated, San Diego, CA (US)

(72) Inventors: Jennifer Lee Gille, Menlo Park, CA (US); Reza Safaee-Rad, Etobicoke (CA); Milivoje Aleksic, San Diego, CA (US)

(21) Appl. No.: 14/692,436

(22) Filed: Apr. 21, 2015

Related U.S. Application Data
(60) Provisional application No. 61/983,390, filed on Apr. 23, 2014.

(51) Int. Cl. G09G 3/20; G06F 3/0484; G09G 5/02

(52) U.S. Cl. CPC G09G 3/2003; G09G 5/02; G06F 3/04847; G09G 2320/0606; G09G 2320/0666; G09G 2320/0693; G09G 2320/0242

(57) ABSTRACT

This disclosure describes techniques for calibrating and adjusting the white point of a display. The techniques for calibrating and adjusting the white point of a display may receive data indicative of a target color temperature for a white point of a display, and provide one or more user interface components that allow a user to select between multiple different candidate white points where each of the of the candidate white points has a correlated color temperature that corresponds to the target color temperature Different target white points for a display may exhibit different levels of luminance loss and/or tint. The techniques for calibrating and adjusting the white point of a display may allow a user to evaluate the trade-off between the luminance loss characteristics and/or tint characteristics of different white points.

This application claims the benefit of each of U.S. Provisional Patent Application No. 61/983,390, filed 23 Apr. 2014, the entire content of which is incorporated herein by reference.

### TECHNICAL FIELD

This disclosure relates to displays, and more particularly, to calibration and adjustment techniques used for displays.

### BACKGROUND

A wide variety of devices may include a display for visually presenting images and/or other information. Devices that include a display may include, for example, digital televisions, wireless communication devices, mobile telephones (e.g., cellular or satellite radio telephones), smartphones, personal digital assistants (PDAs), laptop or desktop computers, tablet computers, digital cameras, video cameras, digital media players, video game consoles, video gaming devices, etc.

To render colors correctly on a display, a display processor may perform color correction on an image to be displayed in order to generate a color-corrected image. The display processor may cause the display to display the color-corrected image. Performing color correction may involve adjusting the colors in an image based on a target white point for the display. For example, some color correction techniques may adjust the colors in an image based on a color correction matrix that is determined based on the target white point for the display.

The target white point for a display may refer to a displayed color that is defined to correspond to white in an image that is displayed by the display. In general, target white points that may be used for a display may vary from cooler whites (e.g., “bluish whites”) to warmer whites (e.g., “yellowish whites”). Different target white points may result in different levels of color accuracy in an image reproduced by the display. The best white point to use for a display may be dependent upon the particular image to be displayed and/or upon the desires of the manufacturer and/or end user. The best white point to use may also be dependent on external factors such as illumination conditions. Selecting an appropriate target white point for a display can present significant challenges to the display manufacturer and/or the end user.

### SUMMARY

This disclosure describes techniques for calibrating and adjusting the white point of a display. The techniques for calibrating and adjusting the white point of a display may receive data indicative of a target color temperature for a white point of a display, and provide one or more user interface components that allow a user to select between multiple different candidate white points, where each of the of the candidate white points has a correlated color temperature that corresponds to the target color temperature. A correlated color temperature of a white point may refer to a black-body color temperature that is visually closest to the color of the white point. A black-body color temperature may refer to a color that is emitted by an ideal black-body that is heated to a temperature which corresponds to the black-body color temperature.

Different target white points for a display may exhibit different levels of luminance loss and/or tint, where tint, as used in this disclosure generally refers to a deviation from the black body locus. A display calibration device may allow a user to select different white points to achieve different levels of luminance loss and/or tint, but changing the white point may change the perceived color of the white point. By providing one or more user interface components that allow a user to select between candidate white points that all have the same correlated color temperature, a user may be allowed to select between different white points that have different luminance loss characteristics and/or tint characteristics without the user needing to be concerned with substantially changing the perceived warmth or coolness of the white point.

In one example, this disclosure describes a method that includes receiving, with one or more processors, data indicative of a target color temperature for a white point of a display. The method further includes outputting for display, with the one or more processors, one or more graphical user interface components that allow a user to select between a plurality of candidate white points. Each of the candidate white points has a same correlated color temperature that corresponds to the target color temperature

In another example, this disclosure describes a device that includes one or more processors configured to receive data indicative of a target color temperature for a white point of a display. The one or more processors are further configured to output for display one or more graphical user interface components that allow a user to select between a plurality of candidate white points. Each of the candidate white points has a same correlated color temperature that corresponds to the target color temperature.

In another example, this disclosure describes an apparatus that includes means for receiving data indicative of a target color temperature for a white point of a display. The apparatus further includes means for outputting for display one or more graphical user interface components that allow a user to select between a plurality of candidate white points. Each of the candidate white points has a same correlated color temperature that corresponds to the target color temperature.

In another example, this disclosure describes a non-transitory computer-readable storage medium storing instructions that, when executed, cause one or more processors to receive data indicative of a target color temperature for a white point of a display. The instructions further cause the one or more processors to output for display one or more graphical user interface components that allow a user to select between a plurality of candidate white points. Each of the candidate white points has a same correlated color temperature that corresponds to the target color temperature.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example display calibration system that may be used to implement the display calibration and adjustment techniques of this disclosure.

FIG. 2 is a block diagram illustrating an example display calibration device that may be used in the example display calibration system of FIG. 1.

FIG. 3 is a chromaticity diagram illustrating a black-body radiation locus (i.e., Planckian locus).

FIG. 4 is a diagram illustrating the relative positions of three white points on a chromaticity color space.

FIG. 5 is a conceptual diagram illustrating an example slider that may be provided by a display calibration device according to this disclosure.

FIG. 6 is a conceptual diagram illustrating the example slider of FIG. 5 in the case where the desired/target white point CCT is changed to 6000K.

FIG. 7 is a chromaticity diagram illustrating the range of candidate white points that may be selected by the slider shown in FIG. 6.

FIG. 8 is a conceptual diagram illustrating the example slider of FIG. 5 in the case where the desired/target white point CCT is changed to 6500K.

FIG. 9 is a conceptual diagram illustrating another example slider that may be provided by a display calibration device according to this disclosure.

FIG. 10 is a flow diagram illustrating an example display calibration and adjustment technique according to this disclosure.

FIG. 11 is a flow diagram illustrating another example display calibration and adjustment technique according to this disclosure.

### DETAILED DESCRIPTION

This disclosure describes techniques for calibrating and adjusting the white point of a display. The techniques for calibrating and adjusting the white point of a display may receive data indicative of a target color temperature for a white point of a display, and provide one or more user interface components that allow a user to select between multiple different candidate white points where each of the of the candidate white points has a correlated color temperature that corresponds to the target color temperature. A correlated color temperature of a white point may refer to a black-body color temperature that is visually closest to the color of the white point. A black-body color temperature may refer to a color that is emitted by an ideal black-body that is heated to a temperature which corresponds to the black-body color temperature.

Different target white points for a display may exhibit different levels of luminance loss and/or tint. A display calibration device may allow a user to select different white points to achieve different levels of luminance loss and/or tint, but changing the white point may change the perceived color of the white point. By providing one or more user interface components that allow a user to select between candidate white points that all have the same correlated color temperature, a user may be allowed to select between different white points that have different luminance loss characteristics and/or tint characteristics without the user needing to be concerned with substantially changing the perceived warmth or coolness of the white point. In this way, the techniques of this disclosure may provide guidance in the selection of white points to manufacturers and/or users that desire to achieve a white point having a particular perceived color while maintaining target levels of luminance loss and/or tint for the display.

In some examples, the techniques for calibrating and adjusting the white point of a display may, for each of one or more of the candidate white points, provide (via a user interface) information indicative of luminance loss characteristics associated with the respective candidate white point and/or information indicative of tint characteristics associated with the respective candidate white point. Providing information indicative of luminance loss characteristics and/or tint characteristics associated with candidate white points may allow a user to evaluate the trade-offs between different luminance loss characteristics and/or tint characteristics associated with different white points that have the same correlated color temperature. In this way, the techniques of this disclosure may allow a manufacturer or user to have better insight into the trade-offs of luminance loss vs. tint associated with different white points that may be selected to achieve a desired color temperature.

In some examples, to determine a set of candidate white points that all have the same correlated color temperature, a color calibration device designed according to this disclosure may determine a first candidate white point that has a minimum luminance loss for the correlated color temperature, and determine a second candidate white point that has no color tint for the correlated color temperature. The color calibration device may include in the set of candidate white points the first candidate white point, the second candidate white point, and one or more other candidate white points that are between the first candidate white point and the second candidate white point on an isothermal line that corresponds to the correlated color temperature. Determining the set of candidate white points in this manner may reduce the number of candidate white points that need to be evaluated by a manufacturer or user relative to a set of candidate white points that includes all white points along the isothermal line that corresponds to the correlated color temperature. In this way, the problem of selecting a white point to achieve a desired color temperature may be simplified for manufacturers and/or users.

Moreover, determining the set of candidate white points in the above-described manner generates a set of candidate white points that includes candidate white points that are between two extreme design goals for white point selection, namely maximum luminance regardless of tint and zero tint. Therefore, allowing a user to select between candidate white points in the above-described set of candidate white points effectively allows a user to balance between these two extreme design goals to achieve a particular balance of luminance versus tint. In this way, the problem of selecting a white point to achieve a desired color temperature may be reduced to selecting between candidate white points that are determined to be meaningful and/or useful to the manufacturer and/or user.

In some examples, a user interface may be provided that includes graphical output, such as a slider element (i.e., a slider user interface component). The slider element (also referred to as simply a “slider”) may allow a user to select between candidate white points that all have the same correlated color temperature. In such examples, the slider may be initialized to an initial position that corresponds to a first candidate white point, and the user interface may display data indicative of one or both of a luminance loss and a tint associated with the first candidate white point. Moving the slider from the initial position may cause the user interface to display one or more candidate white points that have amounts of luminance loss and/or tint that differ from that of the first candidate white point. For example, moving the slider in a first direction from the initial position may cause the user interface to select and display a second candidate white point that has a luminance loss that is greater than the luminance loss of the first candidate white point and/or a tint that is less than the tint of the first candidate white point. Similarly, moving the slider in a second direction opposite the first direction from the initial position may cause the user interface to select and display a second candidate white point that has a luminance loss that is less than the luminance loss of the first candidate white point and/or a tint that is greater than the tint of the first candidate white point. Allowing the user to view and select candidate white points via a slider may allow the user to transition between different levels of luminance loss and tint in a smooth and continuous fashion.

In further examples, a first slider position located at a first end of the slider may correspond to a first candidate white point that has a minimum luminance loss for the correlated color temperature, and a second slider position located at a second end of the slider may correspond to a second candidate white point that has no color tint for the correlated color temperature. In such examples, slider positions between the first slider position and the second slider position may correspond to candidate white points that are between the first candidate white point and the second candidate white point on an isothermal line that corresponds to the correlated color temperature. Moving the slider between the first slider position and the second slider position may smoothly transition between a white point with minimum luminance loss and a white point with no tint. In this way, the problem of selecting a white point to achieve a desired color temperature may be reduced to using a slider to compare the luminance loss characteristics and tint characteristics of various candidate white points.

In additional examples, the concepts described herein with respect to luminance loss and tint may be generalized to other display performance characteristics and/or other perceptual image quality metrics in addition to or in lieu of luminance loss characteristics and/or tint characteristics. For example, the techniques of this disclosure may be used to allow a user to view and select between different candidate white points that have different display performance characteristics and/or different perceptual image quality metrics. In some examples, the display performance characteristics may include luminance loss characteristics and the perceptual image quality metrics may include tint characteristics. However, other types of display performance characteristics may also be improved by the techniques described herein.

In some examples, the techniques for calibrating and adjusting the white point of a display described in this disclosure may receive data indicative of a target tint for a white point of a display, and provide one or more user interface components that allow a user to select between multiple different candidate white points where each of the of the candidate white points has a tint that corresponds to the target tint. The tint of a white point may refer to a distance in a color space between the white point and its associated color temperature point on the black-body locus. Example metrics of tint include the CIEΔE2000 color-difference metric and the Euclidean distance in CIE1931 xy chromaticity color space, (e.g., y=\sqrt{(Δx)²+(Δy)²}). By providing one or more user interface components that allow a user to select between candidate white points that all have the same tint, a user may be allowed to select between different white points that have different luminance loss characteristics and/or different correlated color temperatures without requiring the relative trade-off between luminance loss and tint to be changed. In this way, the techniques of this disclosure may allow a user greater flexibility in adjusting the color temperature of a display while still maintaining a manufacturer-specified level of trade-off between luminance loss and tint.

In further examples, the techniques for calibrating and adjusting the white point of a display may, for each of one or more of the candidate white points, provide (e.g., via a user interface) information indicative of luminance loss characteristics associated with the respective candidate white point and/or information indicative of a correlated color temperature associated with the respective candidate white point. Providing information indicative of luminance loss characteristics and/or correlated color temperatures associated with candidate white points may allow a user to evaluate the trade-offs between different luminance loss characteristics and/or correlated color temperatures associated with different white points that have the same tint and/or the same luminance loss vs. tint trade-off.

In additional examples, a user interface may be provided that includes a slider (i.e., a slider user interface component). The slider may allow a user to select between candidate white points that all have the same level of tint and/or the same luminance loss vs. tint trade-off. In such examples, the slider may be initialized to an initial position that corresponds to a first candidate white point, and the user interface may display data indicative of one or both of a luminance loss and a correlated color temperature associated with the first white point. Moving the slider from the initial position may cause the user interface to display one or more candidate white points that have an amount of luminance loss and/or a correlated color temperature that differs from that of the first candidate white point. For example, moving the slider in a first direction from the initial position may cause the user interface to select and display a second candidate white point that has a luminance loss that is greater than the luminance loss of the first candidate white point. Moving the slider in the first direction may also cause the user interface to select and display a second candidate white point that has a correlated color temperature that is less than the correlated color temperature of the first candidate white point. Similarly, moving the slider in a second direction opposite the first direction from the initial position may cause the user interface to select and display a second candidate white point that has a luminance loss that is less than the luminance loss of the first candidate white point. Moving the slider in a second direction opposite the first direction from the initial position may cause the user interface to select and display a second candidate white point that has a correlated color temperature that is greater than the correlated color temperature of the first candidate white point. Allowing the user to view and select candidate white points via a slider may allow the user to transition between different levels of luminance loss and different correlated color temperatures in a smooth and continuous fashion.

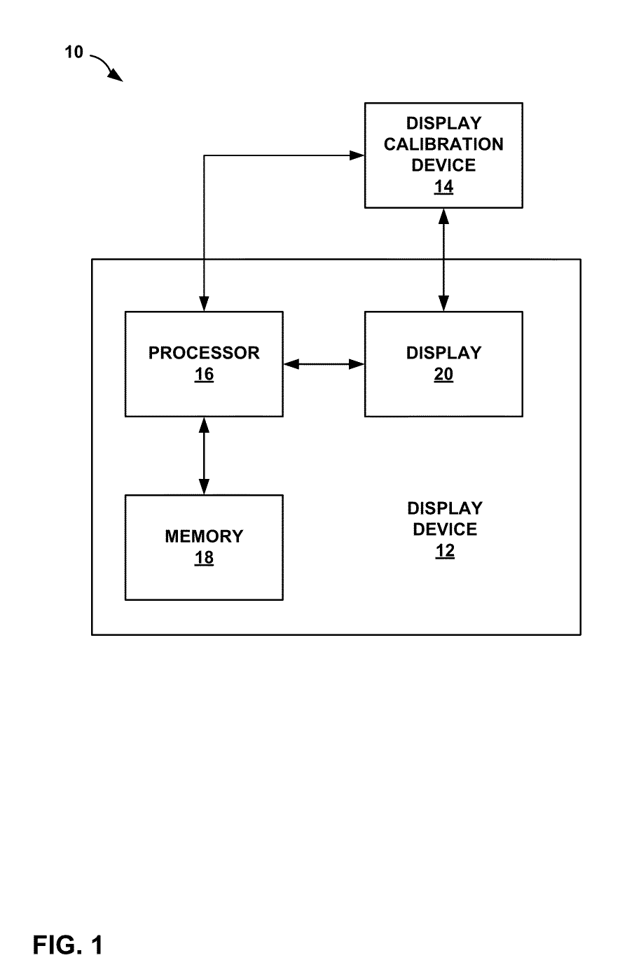

FIG. 1 is a block diagram illustrating an example display calibration system 10 that may be used to implement the display calibration and adjustment techniques of this disclosure. Display calibration system 10 includes a display device 12 and a display calibration device 14.

Display device 12 may be any device (e.g., computing device) that includes a display. For example, display device 12 may be a wireless communication device, a wireless handset (such as, e.g., a mobile phone, examples of which include a cellular or satellite radio telephone, or a smartphone), a personal digital assistant (PDA), a laptop or desktop computer, a digital television, a tablet computer, a digital camera, a video camera, a digital media player, a video game console, a video gaming device, a video conferencing unit, etc. Display device 12 includes a processor 16, a memory 18, and a display 20.

Processor 16 may be configured to process images that are stored in memory 18 or received from another processor, and cause display 20 to display the processed images. Processor 16 may include one or more processors. In some examples, processor 16 may be a display processor, such as, e.g., a Mobile Display Processor (MDP). In further examples, processor 16 may be a central processing unit (CPU), a graphics processing unit (GPU), an image processor, a digital signal processor (DSP), a general purpose microprocessor, an application specific integrated circuit (ASIC), a field programmable logic array (FPGA), a combination of any of the foregoing devices, or other integrated or discrete logic circuitry. Processor 16 may be communicatively coupled to one or both of memory 18 and display 20.

Memory 18 may store image data to be displayed on display 20. Memory 18 may, in some examples, store processed image data that has been processed by processor 16. Memory 18 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data medium or an optical storage medium. Memory 18 may, in some examples, be a non-transitory computer-readable storage medium.

Display 20 may display one or more images (e.g., processed images that are processed by processor 16). Display 20 may be any type of display including, for example, a liquid crystal display (LCD), an organic light-emitting diode display (OLED), a cathode ray tube (CRT) display, a plasma display, or another type of display device. Display 20 may include a plurality of pixels that display 20 illuminates to display the viewable content of an image.

Display calibration device 14 may be configured to calibrate and/or adjust display 20 of display device 12. For example, display calibration device 14 may calibrate and/or adjust the target white point of display device 12 according to one or more of the display calibration and adjustment techniques described in this disclosure. Display calibration device 14 may include one or more processors that are configured to perform all or part of one or more of the display calibration and adjustment techniques described in this disclosure.

In some examples, display calibration device 14 may include one or more user interfaces that are configured to interact with a user. For example, display calibration device 14 may include a display that is configured to display information related to the calibration and adjustment of display 20, e.g., in a textual and/or graphical form. The graphical form, such as a slider described herein, may be particularly useful to allow for user-friendly adjustments in the calibration process. As another example, display calibration device 14 may utilize display 20 as a user interface to display information related to the calibration and adjustment of display 20.

As a further example, the user interfaces of display calibration device 14 may include one or more user input devices that allow a user to provide input to display calibration device 14. Example user input devices include a keyboard, a mouse, a trackball, a microphone, a touch pad, a touch-sensitive or presence-sensitive display, or another input device. In examples where a touch-sensitive or presence-sensitive display is used as a user input device, the display may be integrated with the display of display calibration device 14 that is used to display information related to the calibration and adjustment of display 20.

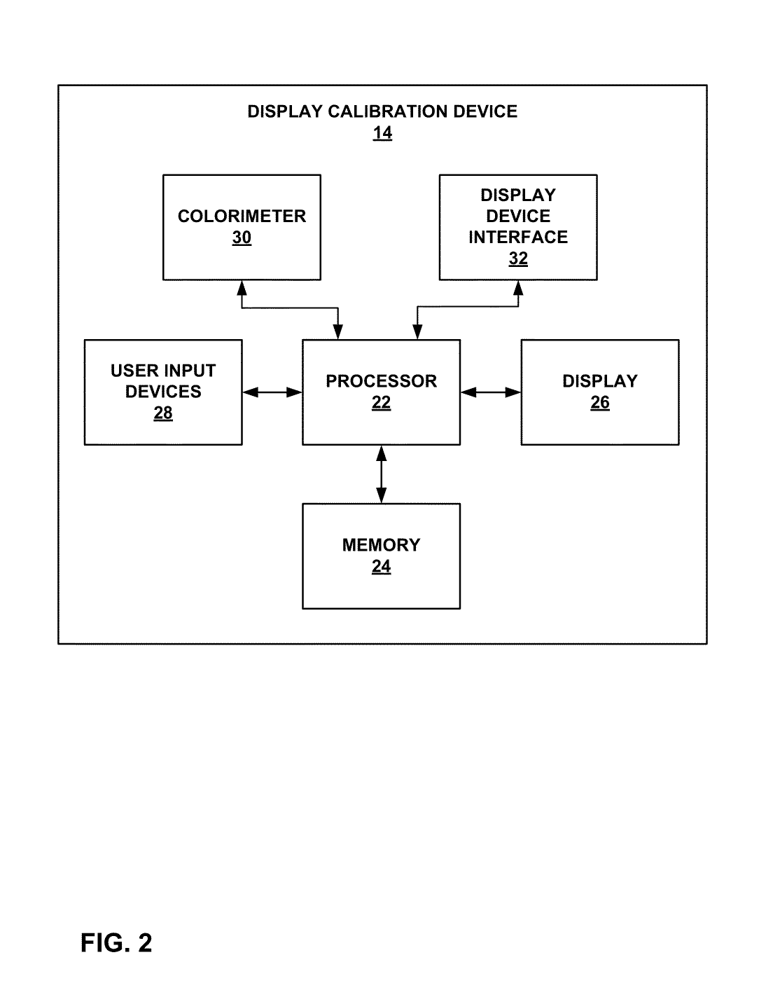

FIG. 2 is a block diagram illustrating an example display calibration device 14 that may be used in the example display calibration system 10 of FIG. 1. Display calibration device 14 includes a processor 22, a memory 24, a display 26, one or more user input devices 28, a colorimeter 30, and a display device interface 32.

Processor 22 may be configured to perform one or more display calibration and/or adjustment algorithms, and to calibrate a display via display device interface 32 based on the results of the display calibration and/or adjustment algorithms. In some examples, processor 22 may be a central processing unit (CPU), a general purpose microprocessor, an application specific integrated circuit (ASIC), a field programmable logic array (FPGA), a combination of any of the foregoing devices, or other integrated or discrete logic circuitry. Processor 22 may be communicatively coupled to one or more of memory 24, display 26, user input devices 28, colorimeter 30 and display device interface 32.

Memory 24 may store program code to implement one or more display calibration and/or adjustment algorithms. Memory 24 may also store calibration data associated with the display calibration and/or adjustment algorithms. Memory 24 may include one or more volatile or non-volatile memories or storage devices, such as, for example, random access memory (RAM), static RAM (SRAM), dynamic RAM (DRAM), read-only memory (ROM), erasable programmable ROM (EPROM), electrically erasable programmable ROM (EEPROM), Flash memory, a magnetic data medium or an optical storage medium. Memory 24 may, in some examples, be a non-transitory computer-readable storage medium.

Display 26 may display one or more images (e.g., processed images that are processed by processor 22). Display 26 may be any type of display including, for example, a liquid crystal display (LCD), an organic light-emitting diode display (OLED), a cathode ray tube (CRT) display, a plasma display, or another type of display device.

User input devices 28 may include one or more user input devices that allow a user to provide input to display calibration device 14. Example user input devices include a keyboard, a mouse, a trackball, a microphone, a touch pad, a touch-sensitive or presence-sensitive display, or another input device. In examples where a touch-sensitive or presence-sensitive display is used as one of user input devices 28, the user input device may be integrated with display 26 to display information related to the calibration and adjustment of another display (e.g., display device 12).

In further examples, processor 22 may display information related to the calibration and adjustment of another display (e.g., display device 12) on the display itself (e.g., display 20 of display device 12). In such examples, processor 22 may use display device interface 32 to communicate with display device 12 to display the calibration information.

Colorimeter 30 may perform native white point measurements on a display (e.g., display 20 of display device 12). Processor 22 may use the native white point measurements to determine one or both of luminance loss and tint associated with candidate white points. Colorimeter 30 may, for example be any of a colorimeter, photometer, spectraphotometer, or other device configured to measure the light emitted by the display.

Display device interface 32 may provide a communication interface between display calibration device 14 and display device 12. Display device interface 32 may be any type of wired or wireless interface, and the communication protocol may be any type of communication protocol.

Black-body radiation is a well-defined physical concept. A black body, when heated, may emit broadband electromagnetic radiation. When the temperature of the black body is in the range from about 1000 to 100,000° K, the emitted radiation (i.e., the light) may be visible to the human visual system.

As the temperature of the black body is raised, the broadband light may appear to the standard human observer to change color from red to orange to yellow to white to blue. Because of this association of color with the black-body radiation, the term color temperature (CT) may be used as a shorthand for light whose spectral content may not be broadband at all, but which appears to be the same color as the black-body radiation at that temperature.

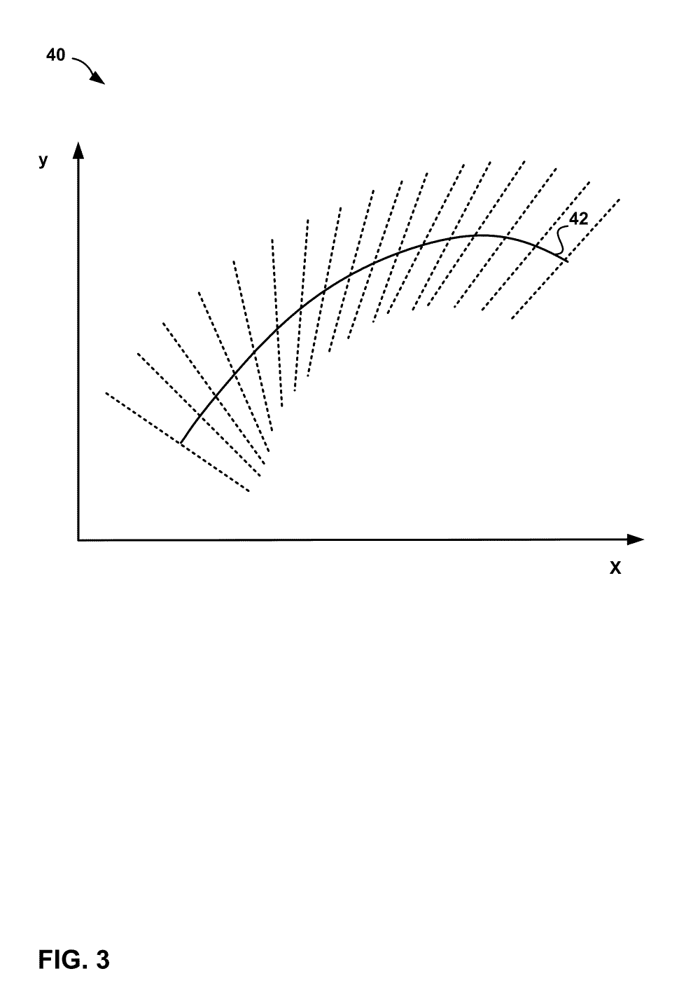

FIG. 3 is a chromaticity diagram 40 illustrating a black-body radiation locus 42 (i.e., Planckian locus). In some examples, chromaticity diagram 40 may be an International Commission on Illumination (CIE) 1931 (x, y) chromaticity diagram. As shown in FIG. 3, the solid curved line in the center represents black-body radiation locus 42.

The (x, y) chromaticity diagram 40 shown in FIG. 3 may be useful for describing the sensation of color, but the function mapping spectral content to (x, y) value is many-to-one. Light of whatever spectral content that maps, via the standard observer functions, to a point on the black-body curve may be said to have the corresponding CT.

Often, radiated light (e.g., light from a fluorescent bulb) will have an (x, y) value that is close to the black-body locus but not on it. In order to describe the color of that light, it can be identified by the CT of the visually closest color that is on the curve. The light is then said to have a correlated color temperature (CCT) of the CT. For example, a light with (x, y) value of (0.34, 0.28) is said to have a CCT of 5000° K. For each CT, the locus of points with the same CCT is a line segment through the CT. The line segment is called the isotemperature line (or isothermal line). The isotemperature lines are represented in FIG. 3 by the dashed line segments crossing the CT curve. Each of the different isotemperature lines may correspond to a different CCT.

A white point that is not on the black-body locus may be described by its CCT and may have a tint relative to its CT. In general, the further the white point is from the black-body curve, the greater the relative tint it will have.

A white point defined by a CCT value may inherently represent a one-to-many mapping problem. That is, there are many white points (with different chromaticity xy coordinates) that have the same CCT value. The techniques of this disclosure may, in some examples, use a set of meaningful/functional/useful constraints that lead to a closed-form solution.

In some examples, the following two constraints may be used to address the above-described problem in the context of white point calibration and adjustments for displays:

(a) No color tint in the target white point, and

(b) Minimum luminance loss for the target white point.

In the context of displays, any adjustment in a display's native white point may lead to luminance loss. Display luminance loss may be a significant design factor for all displays, and in particular, for displays used in mobile devices.

The above two constraints lead to two specific points on the isotemperature line for any specific desired/target CCT value:

(a) One point on the black body curve (point BB (i.e., black body)) which has inherently no color tint at that CCT while it has possibly substantial luminance loss; and

(b) Another point (point MLL (i.e., minimum luminance loss)) which has minimum luminance loss at that CCT but may have color tint.

The above-described constraints open the possibility of selecting a desirable white point by balancing between two factors:

(a) White point color accuracy; and

(b) White point luminance maximization.

In some examples, the techniques of this disclosure may define/frame the problem of display white point calibration and adjustment in terms of balancing between white point color accuracy and white point luminance maximization. In further examples, the techniques of this disclosure may provide a mathematical solution to the problem as defined/framed above in the previous example.

In additional examples, the techniques of this disclosure may estimate a solution to the problem described in the previous example with a minimum number of measurements. It may be shown through analytical and experimental data collection/analysis that when the display native red/green/blue (R/G/B) gammas are not known, white point calibration and adjustment can be achieved using as few as two sets of measurements: R/G/B at max (level 255 for 8 bit panel) and R/G/B at some intermediate level (e.g., level 158 for an 8 bit panel).

An example white point calibration according to one or more of the techniques in this disclosure is now described with respect to TABLE 1:

TABLE 1
Example white point calibration technique.

Condition:

Display RGB gammas are not known in advance.

Inputs:

Display desired white point CCT - 5500K
Display R/G/B @ 255 measured XYZ color coordinates

R_Max_X = 146.1
R_Max_Y = 84.94
R_Max_Z = 11.72
G_Max_X = 166.5
G_Max_Y = 279.9
G_Max_Z = 54.42
B_Max_X = 88.83
B_Max_Y = 58.37
B_Max_Z = 442.8

Display R/G/B @ 158 measured XYZ color coordinates

R_158_X = 49.57
R_158_Y = 28.90
R_158_Z = 4.215
G_158_X = 55.89
G_158_Y = 93.50
G_158_Z = 17.69
B_158_X = 29.07
B_158_Y = 19.80
B_158_Z = 143.8

Outputs:
Based on the algorithm developed and the above measurements from a
LCD display, the following data are generated during white point
calibration:

| Native white point CCT: | 7330K |
|---|---|
| Native white point xy: | 0.3010, |
| | 0.3174 |
| White point @ BB with CCT = | 0.3328, |
| 5500K: | 0.3410 |
| White point @ MLL with CCT = | 0.3328, |
| 5500K: | 0.3635 |
| Color tint @ BB: | None |
| Color tint @ MLL: | Yes |
| Luminance loss @ BB: | 19.9% |
| Luminance loss @ MLL: | 5.5% |

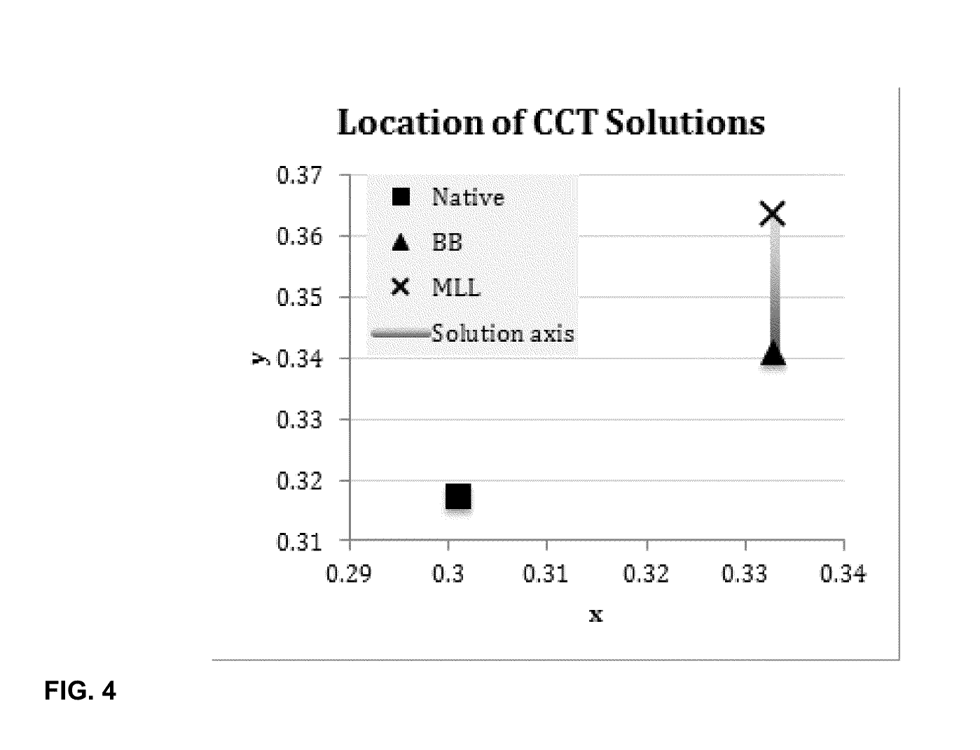

FIG. 4 is a diagram illustrating the relative positions of three white points on a chromaticity color space. The square in FIG. 4 indicates (x, y) color coordinates that correspond to the native white point for the display. A native white point for a display may refer to the color that is displayed by a display when the red, green, blue (RGB) settings are set to their maximum values.

The triangle and “X” in FIG. 4 indicate white points that are part of a set of candidate white points that correspond to a specified correlated color temperature (CCT). The triangle in FIG. 4 indicates (x, y) color coordinates corresponding to a candidate white point that has the specified CCT and that lies on the black-body locus (BB). Because the triangle corresponds to a candidate white point that lies on the BB, the triangle may also correspond to a candidate white point that has the specified CCT and that has no tint. The “X” in FIG. 4 indicates (x, y) color coordinates corresponding to a candidate white point that has the specified CCT and that has minimum luminance loss (MLL).

In the above plot, a line is drawn between the two estimated white points: BB and MLL. This linear path between the two white points may provide an easy and efficient way to establish a desirable white point which leads to a desired balance between the allowable luminance loss and acceptable color tint in the target white point. In some examples, this linear path may correspond to a portion of one of the isothermal lines illustrated in FIG. 3.

Generally, if an equipment manufacturer would like to reduce luminance loss when they calibrate/adjust the white point of a display, the equipment manufacturer may decide to sacrifice a certain level of color tint to achieve an acceptable level of luminance loss. In the above example, if an equipment manufacturer would like to reduce the luminance loss to a maximum of approximately 13%, the equipment manufacturer may select a white point that is located at a point on the line illustrated in FIG. 4 (with length of L) with a distance of approximately (½)*L from the BB point and approximately (½)*L from the MLL point. If the equipment manufacturer would like to measure the amount of tint introduced when not on the BB point, the equipment manufacturer may calculate the ΔE2000 difference between the BB point and each of the other two points, MLL and the intermediate point. The above process of calibrating the white point by adjusting the white point along the line illustrated in FIG. 4 may be provided in a display calibration and tuning tool (e.g., display calibration device 14 shown in FIG. 1).

In some examples, display calibration device 14 may provide one or more graphical user interface (GUI) components that allow a user to selectively move between different candidate white points that lie on the isothermal line between the MLL point and the BB point. For example, display calibration device 14 may provide or display a slider (i.e., a GUI component) that allows a user to move between points on the isothermal line between the MLL point and the BB point. In other examples, textual elements or other types of output may be used. However, the use of a slider that allows a user to move between points on the isothermal line between the MLL point and the BB point may provide advantages in terms of usability and convenience.

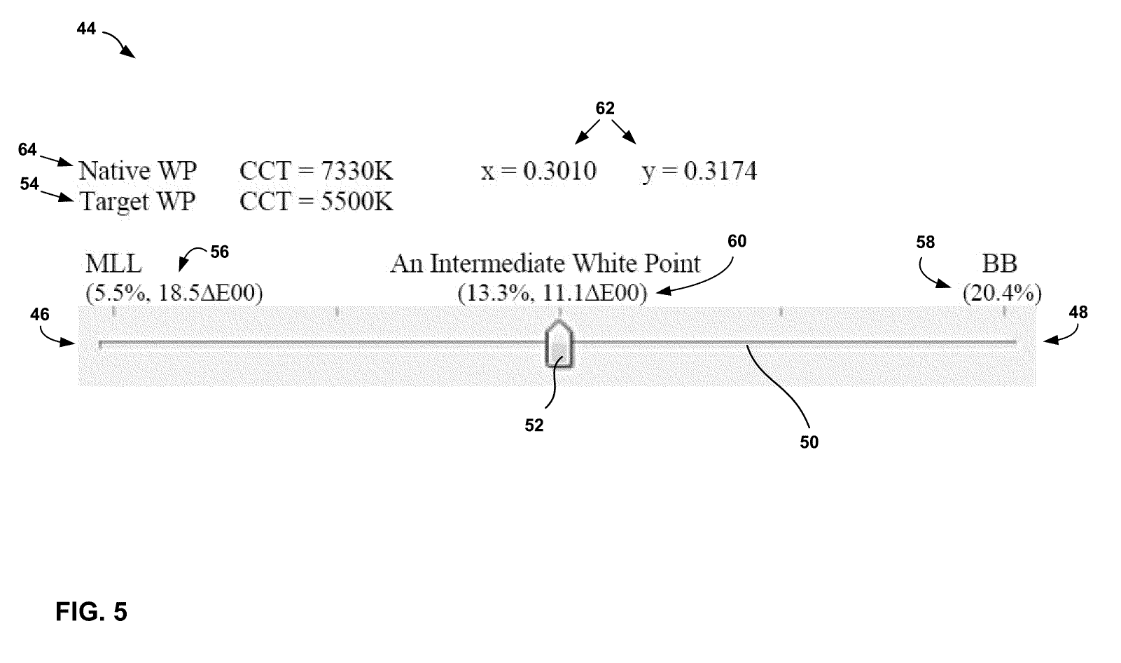

FIG. 5 is a conceptual diagram illustrating an example slider 44 that may be provided by a display calibration device according to this disclosure. Slider 44 includes ends 46, 48, a slider track 50, and a slider control 52.

As an operator moves the slider (e.g., slider control 52) to the left or to the right along slider track 50, display calibration device 14 may calculate and display the luminance loss and the ΔE2000 color difference compared to the BB candidate white point so that white point adjustment impact on the displayed image can be observed, in some examples, in real time. In some examples, an operator may change the target/desired white point CCT, and display calibration device 14 may generate data for the BB and the MLL candidate white points in real time (based on already collected measurement data during calibration) and display the data with a GUI.

As also shown in FIG. 5, the GUI may include a field 54 that is configured to receive user input or data indicative of a target CCT (i.e., a target white point). The target CCT in FIG. 5 is 5500K. A first end 46 of slider 44 may correspond to a candidate white point that has a minimum luminance loss for the target CCT (i.e., MLL candidate white point), and a second end 48 of slider 44 may correspond to a candidate white point that has no tint for the target CCT (BB candidate white point).

In response to receiving the data indicative of the target CCT, display calibration device 14 may determine an MLL candidate white point that corresponds to the target CCT, and display one or more characteristics of the MLL candidate white point in field 56. In the example of FIG. 5, display calibration device 14 displays the luminance loss (5.5%) associated with the MLL candidate white point, and the tint (18.5ΔE00) also associated with the MLL candidate white point.

Also in response to receiving the data indicative of the target CCT, display calibration device 14 may determine a BB candidate white point that corresponds to the target CCT, and display one or more characteristics of the BB candidate white point in field 58. In the example of FIG. 5, display calibration device 14 displays the luminance loss (20.4%) associated with the BB candidate white point. Candidate white points located on the black-body locus have no tint, so the tint for the BB candidate white point is not displayed in this example.

Slider track 50 may include a plurality of slider positions into which slider control 52 may be positioned. Each of the slider positions between end 46 and end 48 may be mapped to a respective candidate white point on a linear line segment that is formed between the MLL candidate white point and the BB color point in a color space. The linear line segment may be a portion of the isothermal line that corresponds to the target CCT specified in field 54. An example line segment between an MLL candidate white point and a BB candidate white point is shown in FIG. 4.

In the example of FIG. 5, the candidate white points may be mapped to slider positions such that the luminance loss associated with the candidate white points monotonically increases from end 46 to end 48, the tint associated with the candidate white points monotonically decreases from end 46 to end 48, and the CCT of the candidate white points remains substantially the same. In this way, a user may be able to view the trade-off between luminance loss characteristics and tint characteristics associated with different candidate white points having a particular CCT in a relatively easy and intuitive manner.

As shown in FIG. 5, slider control 52 is positioned in an initial position, which in this example, is the middle of slider 44. In other examples, the initial position may be at some other location on slider track 50 (e.g., end 46 or end 48). As the slider is moved to the right (i.e., in a first direction), the luminance loss associated with the candidate white points increases, and the tint associated with the candidate white points decreases. Similarly, as the slider is moved to the left (i.e., in a second direction), the luminance loss associated with the candidate white points decreases, and the tint associated with the candidate white points increases

As discussed above, each slider position of slider 44 may be associated with a candidate white point. Display calibration device 14 may display one or more characteristics of the candidate white point that corresponds to the current slider position (i.e., the slider position in which slider control 52 is positioned). In the example of FIG. 5, display calibration device 14 displays the luminance loss (13.3%) and tint (11.1ΔE00) for the candidate white point that corresponds to the current slider position in field 60.

Display calibration device 14 may dynamically update the characteristics (e.g., luminance loss and tint) as the slider is moved based on the current slider position. For example, in response to a user moving slider control 52 to a new slider position, display calibration device 14 may determine the candidate white point that corresponds to the new slider position, determine the luminance loss and tint associated with the determined candidate white point, and display the luminance loss and tint associated with the determined candidate white point.

Display calibration device 14 may display the (x, y) color coordinates associated with the candidate white point that corresponds to the current slider position in field 62. As slider control 52 of slider 44 is moved, display calibration device 14 may update the (x, y) color coordinates based on the current slider position.

Display calibration device 14 may also display data indicative of a CCT for a native white point of a display to be calibrated (e.g., display 20 of display device 12) in field 64. In the example of FIG. 5, the native white point has a CCT of 7330K.

In some examples, display calibration device 14 may receive user input or configuration data indicative of the CCT of the native white point of the display. In further examples, display calibration device 14 may measure the native white point of the display (e.g., by using colorimeter 30).

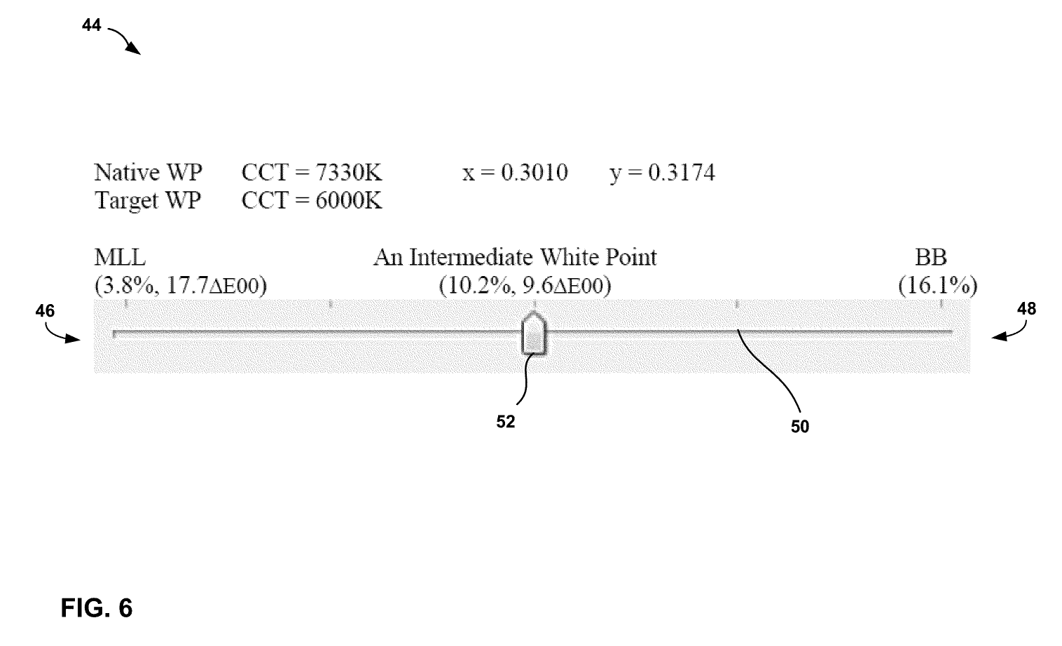

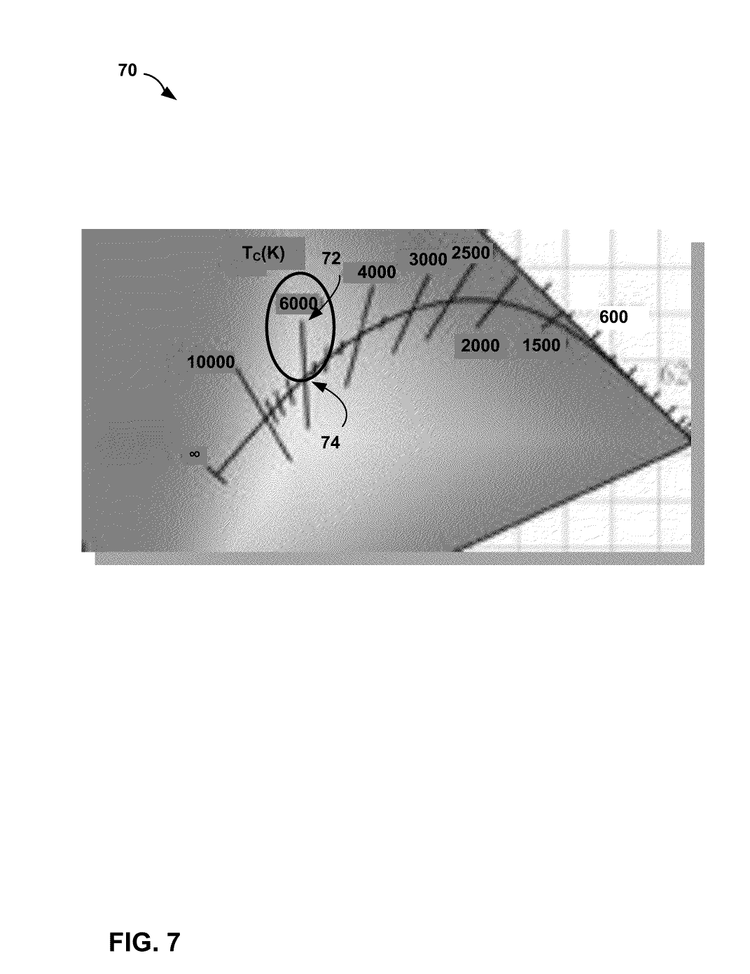

FIG. 6 is a conceptual diagram illustrating the example slider of FIG. 5 in the case where the desired/target white point CCT is changed to 6000K. FIG. 7 is a chromaticity diagram illustrating the range of candidate white points that may be selected by the slider 44 shown in FIG. 6. As shown in FIG. 7, all of the points lie within the oval on the isothermal line that corresponds to 6000K. End 46 of slider 44 in FIG. 6 may correspond to point 72 in FIG. 7. Similarly, end 48 of slider 44 in FIG. 6 may correspond to point 74 in FIG. 7. The slider positions between end 46 and end 48 in FIG. 6 may correspond to the positions on the isothermal line between point 72 and point 74 in FIG. 7. As the slider is moved in display 20, the (x,y) color coordinates of the candidate white point corresponding to the current slider position may move along the isothermal line between point 72 and point 74.

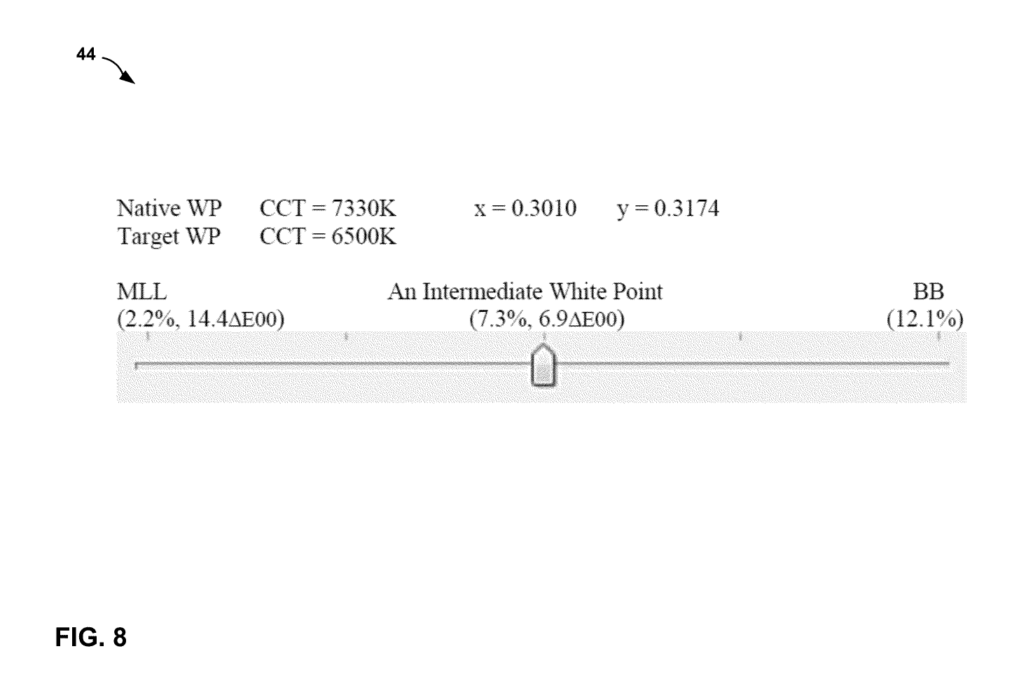

FIG. 8 is a conceptual diagram illustrating the example slider of FIG. 5 in the case where the desired/target white point CCT is changed to 6500K. As shown in FIGS. 6-8, as the target CCT is changed, the MLL and BB are dynamically updating along with the corresponding characteristics (i.e., luminance loss and tint).

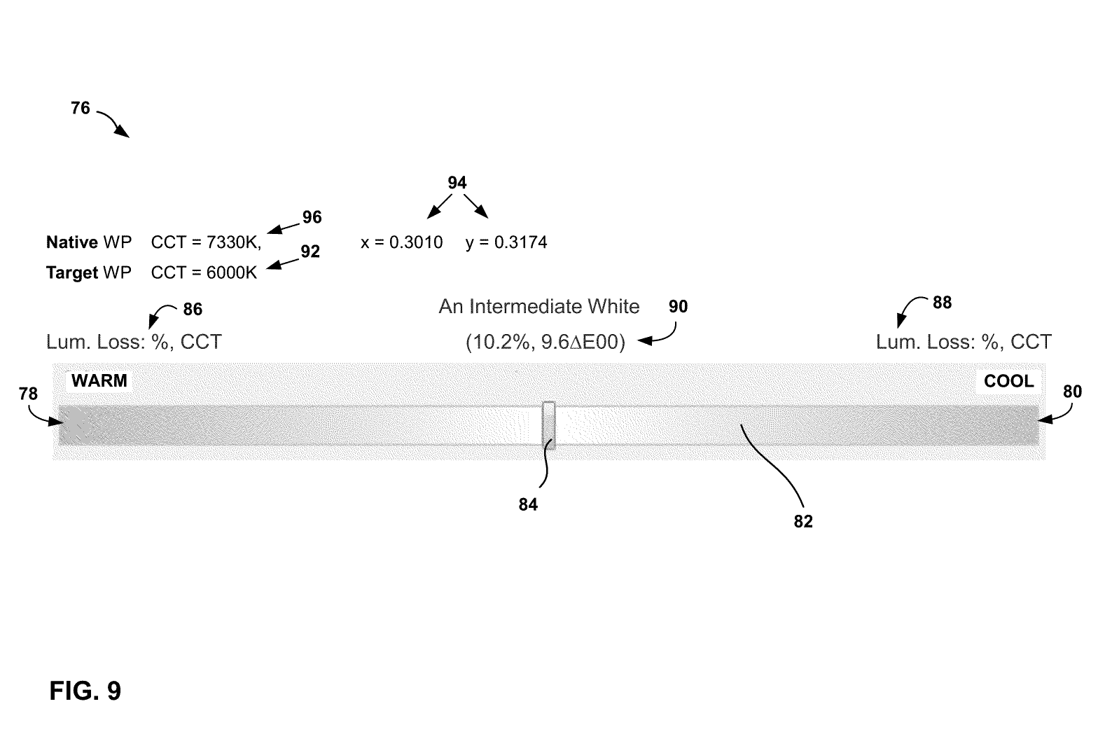

FIG. 9 is a conceptual diagram illustrating another example slider that may be provided by a display calibration device according to this disclosure. Slider 44 includes ends 78, 80, a slider track 82, and a slider control 84. As an operator moves the slider (e.g., slider control 84) to the left or to the right along slider track 82, display calibration device 14 may calculate and display the luminance loss and correlated color temperature so that white point adjustment impact on the displayed image can be observed, in some examples, in real time.

To display slider 76, display calibration device 14 may obtain data indicative of a target tint. In some examples, the target tint may be set by the manufacturer. In response to receiving the data indicative of the target tint, display calibration device 14 may determine a range of candidate white points that all have tints corresponding to the target tint, and map the candidate white points to slider positions along slider track 82 of slider 76.

In response to obtaining the data indicative of the target tint, display calibration device 14 may determine a warmest candidate white point to be displayed for the target tint, and display one or more characteristics of the warmest candidate white point in field 86. In the example of FIG. 9, display calibration device 14 displays the luminance loss associated with the warmest candidate white point, and the CCT associated with the warmest candidate white point.

Also in response to receiving the data indicative of the target tint, display calibration device 14 may determine a coolest candidate white point to be displayed for the target tint, and display one or more characteristics of the coolest candidate white point in field 88. In the example of FIG. 9, display calibration device 14 displays the luminance loss associated with the coolest candidate white point, and the CCT associated with the coolest candidate white point. In the example of FIG. 9, a first end 78 of slider 76 may correspond to the warmest candidate white point to be displayed on slider 76, and a second end 80 of slider 76 may correspond to the coolest candidate white point to be displayed on slider 76.

In the example of FIG. 9, the candidate white points may be mapped to slider positions such that the CCT of the candidate white points monotonically increase from end 78 to end 80, and the tint of the candidate white points remains substantially the same. In this way, a user may be able to view different colored white points that all have the same tint and/or trade-off between luminance loss characteristics and tint characteristics in a relatively easy and intuitive manner.

As shown in FIG. 9, slider control 84 is positioned in an initial position, which in this example, is the middle of slider 76. In other examples, the initial position may be at some other location on slider track 82 (e.g., end 78 or end 80). As the slider is moved to the right (i.e., in a first direction), the CCT associated with the candidate white points increases. Similarly, as the slider is moved to the left (i.e., in a second direction), CCT with the candidate white points decreases.

As discussed above, each slider position of slider 76 may be associated with a candidate white point. Display calibration device 14 may display one or more characteristics of the candidate white point that corresponds to the current slider position (i.e., the slider position in which slider control 84 is positioned). In the example of FIG. 9, display calibration device 14 displays the luminance loss (10.2%) and tint (9.6ΔE00) for the candidate white point that corresponds to the current slider position in field 90. Display calibration device 14 also displays the CCT for the candidate white point that corresponds to the current slider position in field 90.

Display calibration device 14 may dynamically update the characteristics (e.g., luminance loss, CCT) as the slider is moved based on the current slider position. For example, in response to a user moving slider control 84 to a new slider position, display calibration device 14 may determine the candidate white point that corresponds to the new slider position, determine the luminance loss and CCT associated with the determined candidate white point, and display the luminance loss and CCT associated with the determined candidate white point.

Display calibration device 14 may display the (x, y) color coordinates associated with the candidate white point that corresponds to the current slider position in field 94. As slider control 84 of slider 76 is moved, display calibration device 14 may update the (x, y) color coordinates based on the current slider position.

Display calibration device 14 may also display data indicative of a CCT for a native white point of a display to be calibrated (e.g., display 20 of display device 12) in field 96. In the example of FIG. 5, the native white point has a CCT of 7330K.

In some examples, display calibration device 14 may receive user input or configuration data indicative of the CCT of the native white point of the display. In further examples, display calibration device 14 may measure the native white point of the display (e.g., by using colorimeter 30).

Display manufacturers often specify the desired white of a display in terms of CT. Thus, the balance of the given RGB channels that will produce the desired (x, y) value for white may need to be discovered. However, the intent of display manufacturers may actually be to achieve a certain CCT, if achieving the exact CT (x, y) coordinates would produce undesirable results (e.g., a loss of brightness).

In some examples, the techniques of this disclosure (which may be implemented in a display calibration device) may allow a display manufacturer to choose the desired white point for a display. The techniques of this disclosure may, in some examples, take into account both the intent of the display manufacturer and potential trade-offs in brightness and tint. In some examples, the techniques of this disclosure may operate based on the insight that, at the two extremes of intent for a given CCT (i.e., maximum luminance regardless of tint and zero tint by reason of being on the black-body curve) are the endpoints of a range of choices that lie on a line. A display calibration device may calculate these endpoints and provide the user with a slider between them.

In some examples, the candidate white point for a specified correlated color temperature that lies on the black-body locus (BB) may be calculated based on an approximation algorithm that uses tables (e.g., look-up tables). For example, the BB candidate white point may be calculated based on an approximation algorithm described in Wyszecki & Stiles from Wyszecki & Stiles, “Color Science Concepts and Methods, Quantitative Data and Formulae,” 2nd Edition, John Wiley & Sons, Inc., 2000, the entire content of which is incorporated herein by reference (See, e.g., the approximation algorithm described in conjunction with FIG. 1(3.11) of Wyszecki & Stiles).

In some examples, the candidate white point for a specified correlated color temperature that has minimum luminance loss (MLL) may be calculated based on the following expressions and/or equations:
Let RX, RY, and RZ be the measured X, Y and Z values for full-on red (i.e., [255, 0, 0]).

Similarly, for GX, GY, GZ (full-on green, [0, 255, 0]) and BX, BY, BZ (full-on blue, [0, 0, 255]).
Let CCT_{N} be the native CCT, and CCT_{T} be the target, or desired, CCT.
Let invSlope and xIntercept be parameters defining the isotemperature line for CCT_{T}.
   In some examples, the invSlope and xIntercept parameters may be derived from Table 3.11, p. 228, in Wyszecki & Stiles, “Color Science Concepts and Methods, Quantitative Data and Formulae,” 2nd Edition, John Wiley & Sons, Inc., 1982, the entire content of which is incorporated herein by reference.

Based on the above-described parameters, the linear multipliers for R, G and B that will produce a white point with the desired CCT and minimum luminance loss, MLL, (hereinafter referred to as “RGBmultipliers” or as “the RGB vector of multipliers”) may be calculated based on the following expressions and/or equations:

TABLE 2
Example MLL candidate white point calculation technique.

If CCTT < CCTN

reductionFactor = (RX + GX − (RY + GY) * invSlope − xIntercept *

(R + G))/. . . (−BX + BY * invSlope + xIntercept * B)

reductionFactor = min(reductionFactor, 1)
RGBmultipliers = [1, 1, reductionFactor]

If CCTT > CCTN

reductionFactor = (GX + BX − (GY + BY) * invSlope − xIntercept *

(G + B))/. . . (−RX + RY * invSlope + xIntercept * R)

reductionFactor = min(reductionFactor, 1)
RGBmultipliers = [reductionFactor, 1, 1]

If CCTT = CCTN
The multipliers for R, G and B are: [1, 1, 1]

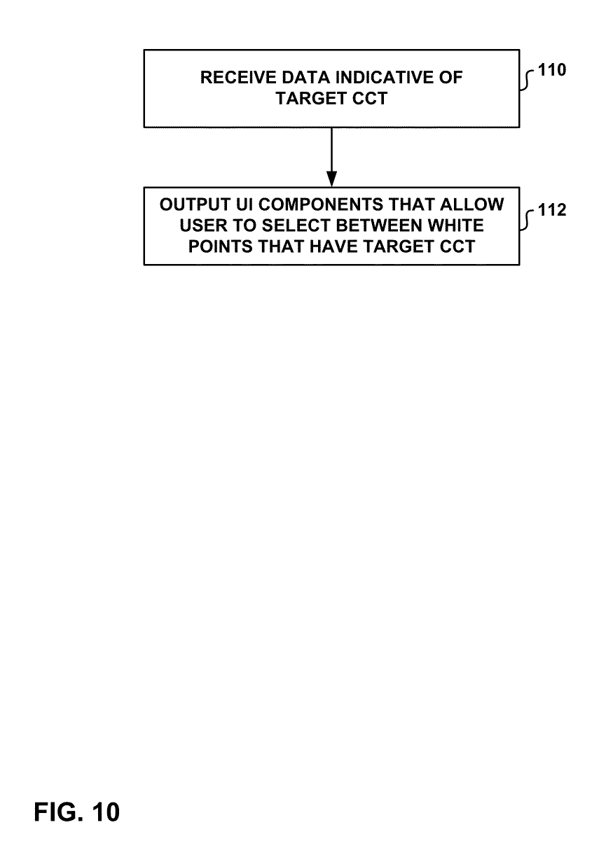

FIG. 10 is a flow diagram illustrating an example display calibration and adjustment technique according to this disclosure. In some examples, the techniques described in FIG. 10 may be implemented with one or both of display device 12 and display calibration device 14.

Processor 16 and/or processor 22 receives data indicative of a target color temperature for a white point of a display (110). Processor 16 and/or processor 22 outputs for display one or more graphical user interface components that allow a user to select between a plurality of candidate white points, where each of the candidate white points has a same correlated color temperature that corresponds to the target color temperature (112). In some examples, each of the candidate white points may correspond to a respective set of (x,y) color coordinates in a color space.

In some examples, the plurality of candidate white points may include a first candidate white point (MLL) that has a minimum luminance loss for the target correlated color temperature, a second candidate white point (BB) that has no color tint for the target correlated color temperature, and one or more additional candidate white points that are between the first candidate white point and the second candidate white point on an isothermal line in a color space, the isothermal line corresponding to the target correlated color temperature. In such examples, the one or more graphical user interface components may include, in some examples, one or more components that allow a user to selectively traverse the candidate white points, starting from an initial candidate white point, in an order that corresponds to an order in which the candidate white points are located on the isothermal line.

In some examples, each of the candidate white points is associated with a respective luminance loss and a respective tint. In such examples, one or more graphical user interface components may include one or more components that allow a user to selectively traverse an ordered sequence of the candidate white points, starting from an initial candidate white point in the ordered sequence, in an order defined by the ordered sequence. In such examples, the luminance loss associated with the candidate white points monotonically increases from a beginning of the ordered sequence to an end of the ordered sequence, the tint associated with the candidate white points monotonically decreases from the beginning of the ordered sequence to the end of the ordered sequence, and the correlated color temperature of the candidate white points remains substantially constant from the beginning of the ordered sequence to the end of the ordered sequence.

In some examples, the one or more graphical user interface components may include a slider 44 that allows a user to select between the candidate white points that all have the same correlated color temperature. In such examples, each of the candidate white points, in some examples, may be associated with a respective luminance loss and a respective tint. In such examples, the candidate white points may be mapped to slider positions of slider 44 such that the luminance loss associated with the candidate white points monotonically increases from a first end 46 of slider 44 to a second end 48 of slider 44 opposite the first end 46 of slider 44, the tint associated with the candidate white points monotonically decreases from the first end 46 of slider 44 to the second end 48 of slider 44, and the correlated color temperature of the candidate white points remains substantially constant from the first end 46 of slider 44 to the second end 48 of slider 44.

In such examples, when slider 44 is positioned in each of slider 44 positions, processor 16 and/or processor 22 may output for display data indicative of a luminance loss associated with the candidate white point that corresponds to the respective slider position and a tint associated with the candidate white point that corresponds to the respective slider position.

In some examples, slider 44 may be configurable to be positioned in a plurality of slider positions, each of slider 44 positions may correspond to a respective one of the candidate white points. Slider 44 positions may include a first slider position located at a first end 46 of slider 44, and a second slider position located at a second end 48 of slider 44 opposite the first end 46 of slider 44. The first slider position may correspond to a first candidate white point that has a minimum luminance loss for the target correlated color temperature. The second slider position may correspond to a second candidate white point that has no color tint for the target correlated color temperature. Slider 44 positions between the first slider position and the second slider position may correspond to candidate white points that are between the first candidate white point and the second candidate white point on an isothermal line in a color space. The isothermal line may correspond to the correlated color temperature.

In additional examples, each of the candidate white points may be associated with a respective luminance loss and a respective tint. In such examples, the candidate white points may be mapped to slider 44 positions of slider 44 such that the luminance loss associated with the candidate white points monotonically increases from the first end 46 of slider 44 to the second end 48 of slider 44, the tint associated with the candidate white points monotonically decreases from the first end 46 of slider 44 to the second end 48 of slider 44, and the correlated color temperature of the candidate white points remains substantially constant from the first end 46 of slider 44 to the second end 48 of slider 44.

In further examples, for each of the candidate white points, when the respective candidate white point is selected by a user using the graphical user interface components, display calibration device 14 and/or processor 22 may output for display data indicative of a luminance loss associated with the respective candidate white point and an amount of tint associated with the respective candidate white point.

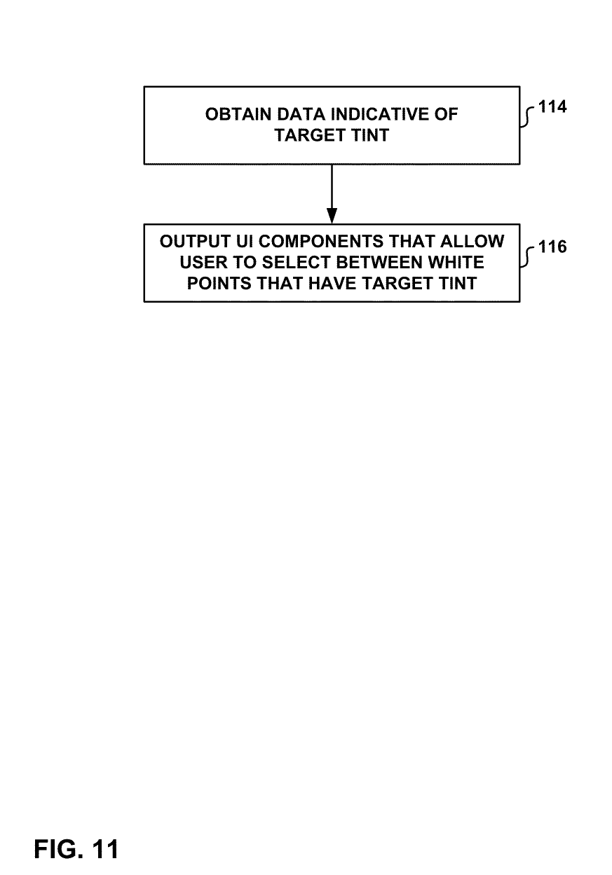

FIG. 11 is a flow diagram illustrating another example display calibration and adjustment technique according to this disclosure. In some examples, the techniques described in FIG. 10 may be implemented with one or both of display device 12 and display calibration device 14.

Display calibration device 14 and/or processor 22 obtains data indicative of a target tint (114). Display calibration device 14 and/or processor 22 outputs for display one or more graphical user interface elements that allow a user to select between candidate white points in a second set of candidate white points, wherein each of the candidate white points in the second set of candidate white points has a same tint that corresponds to a target tint (116).

In some examples, each of the candidate white points in the second set of candidate white points may be associated with a respective correlated color temperature. In such examples, the one or more graphical user interface elements may include one or more graphical elements (e.g., a slider 76) that allow a user to selectively traverse an ordered sequence of the candidate white points in the second set of candidate white points, starting from an initial candidate white point in the ordered sequence, in an order defined by the ordered sequence. In such examples, the correlated color temperature of the candidate white points in the second set of candidate white points may monotonically increase from a beginning of the ordered sequence to an end of the ordered sequence, and the tint associated with the candidate white points in the second set of candidate white points remains substantially constant from the beginning of the ordered sequence to the end of the ordered sequence.

In some examples, images may be viewed under the white-point conditions indicated by the changing slider. In further examples, brightness loss and degree of tint may also be calculated and displayed as the slider changes.

In some examples, if a panel is calibrated and the calibrated data is saved on a target device, then one or more of the sliders described in this disclosure may be provided to the end user through a GUI provided by a display calibration device. In some cases, a calibration tool may execute on a personal computer (PC) or on the display calibration device itself.

In some examples, some or all of the display calibration and adjustment techniques of this disclosure may be performed by one or both of display device 12 (e.g., processor 16) and display calibration device 14 (e.g., one or more processor included in display calibration device 14). In some examples, one or both of display 20 or a display included with (or integrated with) display calibration device 14 may present a graphical user interface (GUI) that presents and receives user input via one or more of the sliders described in this disclosure. In some examples, display calibration device 14 may include a colorimeter to perform native white point measurements and native R, G and B primary measurements, and the native measurements may be used to determine one or both of luminance loss and tint associated with the candidate white points.

In some examples, tint may refer to the deviation of a color having a particular correlated color temperature from the color of the CT on the black-body locus that corresponds to the black-body locus. In further examples, the techniques of this disclosure may output for display a graphical user interface that includes a slider component which allows a user to select between candidate white points that all have the same level of tint relative to the BB point for each of the candidate white points.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry such as discrete hardware that performs processing.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware, firmware, and/or software components, or integrated within common or separate hardware or software components.

The techniques described in this disclosure may also be stored, embodied or encoded in a computer-readable medium, such as a computer-readable storage medium that stores instructions. Instructions embedded or encoded in a computer-readable medium may cause one or more processors to perform the techniques described herein, e.g., when the instructions are executed by the one or more processors. In some examples, the computer-readable medium may be a non-transitory computer-readable storage medium. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable storage media that is tangible.

Computer-readable media may include computer-readable storage media, which corresponds to a tangible storage medium, such as those listed above. Computer-readable media may also comprise communication media including any medium that facilitates transfer of a computer program from one place to another, e.g., according to a communication protocol. In this manner, the phrase “computer-readable media” generally may correspond to (1) tangible computer-readable storage media which is non-transitory, and (2) a non-tangible computer-readable communication medium such as a transitory signal or carrier wave.

Various aspects and examples have been described. However, modifications can be made to the structure or techniques of this disclosure without departing from the scope of the following claims.

What is claimed is:

1. A method comprising:
receiving, with one or more processors, data indicative of a target color temperature for a white point of a display; and
outputting for display, with the one or more processors, one or more graphical user interface elements that allow a user to select between a plurality of candidate white points, wherein each of the candidate white points has a same correlated color temperature that corresponds to the target color temperature.

2. The method of claim 1, wherein the plurality of candidate white points comprise a first candidate white point that has a minimum luminance loss for the target correlated color temperature, a second candidate white point that has no color tint for the target correlated color temperature, and one or more additional candidate white points that are between the first candidate white point and the second candidate white point on an isothermal line in a color space, the isothermal line corresponding to the target correlated color temperature.

3. The method of claim 2, wherein the one or more graphical user interface components comprise one or more components that allow a user to selectively traverse the candidate white points, starting from an initial candidate white point, in an order that corresponds to an order in which the candidate white points are located on the isothermal line.

4. The method of claim 1,
wherein each of the candidate white points is associated with a respective luminance loss and a respective tint,
wherein the one or more graphical user interface components comprise one or more components that allow a user to selectively traverse an ordered sequence of the candidate white points, starting from an initial candidate white point in the ordered sequence, in an order defined by the ordered sequence, and
wherein the luminance loss associated with the candidate white points monotonically increases from a beginning of the ordered sequence to an end of the ordered sequence, the tint associated with the candidate white points monotonically decreases from the beginning of the ordered sequence to the end of the ordered sequence, and the correlated color temperature of the candidate white points remains substantially constant from the beginning of the ordered sequence to the end of the ordered sequence.

5. The method of claim 1, wherein the one or more graphical user interface components comprise a slider that allows a user to select between the candidate white points that all have the same correlated color temperature.

6. The method of claim 5,
wherein each of the candidate white points is associated with a respective luminance loss and a respective tint, and
wherein the candidate white points are mapped to slider positions of the slider such that the luminance loss associated with the candidate white points monotonically increases from a first end of the slider to a second end of the slider opposite the first end of the slider, the tint associated with the candidate white points monotonically decreases from the first end of the slider to the second end of the slider, and the correlated color temperature of the candidate white points remains substantially constant from the first end of the slider to the second end of the slider.

7. The method of claim 6, further comprising:
when the slider is positioned in each of the slider positions, outputting for display data indicative of a luminance loss associated with the candidate white point that corresponds to the respective slider position and a tint associated with the candidate white point that corresponds to the respective slider position.

8. The method of claim 5,
wherein the slider is configurable to be positioned in a plurality of slider positions, each of the slider positions corresponding to a respective one of the candidate white points,
wherein the plurality of slider positions comprises a first slider position located at a first end of the slider, and a second slider position located at a second end of the slider opposite the first end of the slider,
wherein the first slider position corresponds to a first candidate white point that has a minimum luminance loss for the target correlated color temperature,
wherein the second slider position corresponds to a second candidate white point that has no color tint for the target correlated color temperature, and
wherein slider positions between the first slider position and the second slider position correspond to candidate white points that are between the first candidate white point and the second candidate white point on an isothermal line in a color space, the isothermal line corresponding to the correlated color temperature.

9. The method of claim 8,
wherein each of the candidate white points is associated with a respective luminance loss and a respective tint, and
wherein the candidate white points are mapped to the slider positions of the slider such that the luminance loss associated with the candidate white points monotonically increases from the first end of the slider to the second end of the slider, the tint associated with the candidate white points monotonically decreases from the first end of the slider to the second end of the slider, and the correlated color temperature of the candidate white points remains substantially constant from the first end of the slider to the second end of the slider.

10. The method of claim 1, wherein the plurality of candidate white points is a first set of candidate white points, the method further comprising:
outputting for display, with the one or more processors, one or more graphical user interface components that allow a user to select between candidate white points in a second set of candidate white points, wherein each of the candidate white points in the second set of candidate white points has a same tint that corresponds to a target tint.

11. The method of claim 10,
wherein each of the candidate white points in the second set of candidate white points is associated with a respective correlated color temperature,
wherein the one or more graphical user interface components comprise one or more components that allow a user to selectively traverse an ordered sequence of the candidate white points in the second set of candidate white points, starting from an initial candidate white point in the ordered sequence, in an order defined by the ordered sequence, and
wherein the correlated color temperature of the candidate white points in the second set of candidate white points monotonically increases from a beginning of the ordered sequence to an end of the ordered sequence, and the tint associated with the candidate white points in the second set of candidate white points remains substantially constant from the beginning of the ordered sequence to the end of the ordered sequence.

12. The method of claim 1, further comprising:
for each of the candidate white points, when the respective candidate white point is selected by a user using the graphical user interface components, outputting for display data indicative of a luminance loss associated with the respective candidate white point and a tint associated with the respective candidate white point.

13. The method of claim 1, wherein each of the candidate white points corresponds to a respective set of (x,y) color coordinates in a color space.

14. A device comprising one or more processor configured to:
receive data indicative of a target color temperature for a white point of a display; and
output for display one or more graphical user interface components that allow a user to select between a plurality of candidate white points, wherein each of the candidate white points has a same correlated color temperature that corresponds to the target color temperature.

15. The device of claim 14, wherein the plurality of candidate white points comprise a first candidate white point that has a minimum luminance loss for the target correlated color temperature, a second candidate white point that has no color tint for the target correlated color temperature, and one or more additional candidate white points that are between the first candidate white point and the second candidate white point on an isothermal line in a color space, the isothermal line corresponding to the target correlated color temperature.

16. The device of claim 15, wherein the one or more graphical user interface components comprise one or more components that allow a user to selectively traverse the candidate white points, starting from an initial candidate white point, in an order that corresponds to an order in which the candidate white points are located on the isothermal line.

17. The device of claim 14,
wherein each of the candidate white points is associated with a respective luminance loss and a respective tint,
wherein the one or more graphical user interface components comprise one or more components that allow a user to selectively traverse an ordered sequence of the candidate white points, starting from an initial candidate white point in the ordered sequence, in an order defined by the ordered sequence, and
wherein the luminance loss associated with the candidate white points monotonically increases from a beginning of the ordered sequence to an end of the ordered sequence, the tint associated with the candidate white points monotonically decreases from the beginning of the ordered sequence to the end of the ordered sequence, and the correlated color temperature of the candidate white points remains substantially constant from the beginning of the ordered sequence to the end of the ordered sequence.

18. The device of claim 14, wherein the one or more graphical user interface components comprise a slider that allows a user to select between the candidate white points that all have the same correlated color temperature.

19. The device of claim 18,
wherein each of the candidate white points is associated with a respective luminance loss and a respective tint, and
wherein the candidate white points are mapped to slider positions of the slider such that the luminance loss associated with the candidate white points monotonically increases from a first end of the slider to a second end of the slider opposite the first end of the slider, the tint associated with the candidate white points monotonically decreases from the first end of the slider to the second end of the slider, and the correlated color temperature of the candidate white points remains substantially constant from the first end of the slider to the second end of the slider.

20. The device of claim 19, wherein the one or more processors are further configured to, when the slider is positioned in each of the slider positions, output for display data indicative of a luminance loss associated with the candidate white point that corresponds to the respective slider position and a tint associated with the candidate white point that corresponds to the respective slider position.

21. The device of claim 18,
wherein the slider is configurable to be positioned in a plurality of slider positions, each of the slider positions corresponding to a respective one of the candidate white points,
wherein the plurality of slider positions comprises a first slider position located at a first end of the slider, and a second slider position located at a second end of the slider opposite the first end of the slider,
wherein the first slider position corresponds to a first candidate white point that has a minimum luminance loss for the target correlated color temperature, wherein the second slider position corresponds to a second candidate white point that has no color tint for the target correlated color temperature, and
wherein slider positions between the first slider position and the second slider position correspond to candidate white points that are between the first candidate white point and the second candidate white point on an isothermal line in a color space, the isothermal line corresponding to the correlated color temperature.

22. The device of claim 21,
wherein each of the candidate white points is associated with a respective luminance loss and a respective tint, and
wherein the candidate white points are mapped to the slider positions of the slider such that the luminance loss associated with the candidate white points monotonically increases from the first end of the slider to the second end of the slider, the tint associated with the candidate white points monotonically decreases from the first end of the slider to the second end of the slider, and the correlated color temperature of the candidate white points remains substantially constant from the first end of the slider to the second end of the slider.

23. The device of claim 14,
wherein the plurality of candidate white points is a first set of candidate white points, and
wherein the one or more processors are further configured to output for display one or more graphical user interface components that allow a user to select between candidate white points in a second set of candidate white points, wherein each of the candidate white points in the second set of candidate white points has a same tint that corresponds to a target tint.

24. The device of claim 23,
wherein each of the candidate white points in the second set of candidate white points is associated with a respective correlated color temperature,
wherein the one or more graphical user interface components comprise one or more components that allow a user to selectively traverse an ordered sequence of the candidate white points in the second set of candidate white points, starting from an initial candidate white point in the ordered sequence, in an order defined by the ordered sequence, and
wherein the correlated color temperature of the candidate white points in the second set of candidate white points monotonically increases from a beginning of the ordered sequence to an end of the ordered sequence, and the tint associated with the candidate white points in the second set of candidate white points remains substantially constant from the beginning of the ordered sequence to the end of the ordered sequence.

25. The device of claim 14, wherein the one or more processors are further configured to, for each of the candidate white points, when the respective candidate white point is selected by a user using the graphical user interface components, outputting for display data indicative of a luminance loss associated with the respective candidate white point and a tint associated with the respective candidate white point.

26. The device of claim 14, wherein each of the candidate white points corresponds to a respective set of (x,y) color coordinates in a color space.

27. The device of claim 14, wherein the device comprises at least one of a wireless communication device or a mobile phone handset.

28. An apparatus comprising:
means for receiving data indicative of a target color temperature for a white point of a display; and
means for outputting for display one or more graphical user interface components that allow a user to select between a plurality of candidate white points, wherein each of the candidate white points has a same correlated color temperature that corresponds to the target color temperature.

29. A non-transitory computer readable storage medium comprising instructions that upon execution by one or more processors cause the one or more processors to:
receive data indicative of a target color temperature for a white point of a display; and
output for display one or more graphical user interface components that allow a user to select between a plurality of candidate white points, wherein each of the candidate white points has a same correlated color temperature that corresponds to the target color temperature.

30. The non-transitory computer readable medium of claim 29, wherein the plurality of candidate white points comprise a first candidate white point that has a minimum luminance loss for the target correlated color temperature, a second candidate white point that has no color tint for the target correlated color temperature, and one or more additional candidate white points that are between the first candidate white point and the second candidate white point on an isothermal line in a color space, the isothermal line corresponding to the target correlated color temperature.
